(19) United States
(12) Patent Application Publication
(10) Pub. No.: US 2019/0029383 A1
(43) Pub. Date: Jan. 31, 2019

(54) PROTECTIVE CASE WITH SEALED AUDIO PORT

(71) Applicant: OTTER PRODUCTS, LLC, Fort Collins, CO (US)

(72) Inventors: OSCAR L. LOPEZ, DESCANSO, CA (US); AARON M. LIPNER, SAN DIEGO, CA (US); LAN NGUYEN, SAN DIEGO, CA (US); MARINA OKADA, SAN DIEGO, CA (US)

(21) Appl. No.: 16/033,342

(22) Filed: Jul. 12, 2018

Related U.S. Application Data
(60) Provisional application No. 62/538,212, filed on Jul. 28, 2017.

(51) Int. Cl. A45C 13/00; A45C 11/00; H04B 1/3888

(52) U.S. Cl. CPC A45C 13/008; A45C 11/00; A45C 2011/001; A45C 2011/002; A45C 2011/003; H04B 1/3888

(57) ABSTRACT

A protective case for an electronic device having a touch screen and an audio port. The protective case includes a front portion including a rigid frame extending around a perimeter and a screen aperture configured to provide access to the touch screen of the installed electronic device. The protective case includes a back portion removably attached to the front portion and includes a sealing member configured to directly contact a portion of the electronic device. The sealing member has an aperture defining a circumference configured to encircle the audio port of the installed electronic device and form a water-proof seal between the installed electronic device and the sealing member of the protective case. The protective case includes a vent mesh covering the aperture of the sealing member and configured to allow air to pass through the vent mesh and to resist the flow of water through the vent mesh.

### CROSS-REFERENCE TO RELATED APPLICATIONS

This disclosure claims priority to U.S. Provisional Application No. 62/538,212, filed Jul. 28, 2017, the disclosure of which is hereby incorporated by reference in its entirety.

### FIELD

This disclosure relates generally to a protective cases for personal electronic devices.

### BACKGROUND

Personal electronic devices are commonly used for communication, entertainment purposes, as well as Internet access and a variety of other purposes. Examples of personal electronic devices include smartphones, tablet computers, gaming devices, audio players, video players, cameras, portable computers, two-way radios, GPS receivers, smart glasses, virtual reality glasses or helmets, masks or eyewear including an electronic display, and/or other portable devices. Protective cases for electronic devices provide protection for the electronic device from various forms of damage, including damage from dust, water, snow, dirt, and drops. Exemplary protective cases are disclosed in U.S. Pat. Nos. 8,342,325 and 9,300,344, the disclosures of which are hereby incorporated by reference in their entirety.

Many electronic devices include one or more ports, including an audio ports such as for a speaker or a microphone. In order to provide protection from water, an opening proximate to the audio port may be covered with a speaker acoustic material, such as a semi-permeable hydrophobic membrane. Semi-permeable hydrophobic membrane prevent water from passing through the membrane up to certain pressure differences across the membrane. Some sound may be transmitted across the membrane, either from the environment to the electronic device in the case of a microphone port or from the electronic device to the environment in the case of a speaker port, either by passing through the membrane directly, or by the vibration of the membrane itself transmitting the sound. However, the quality or magnitude of the audio may be diminished by passing through the material.

Improvements in the foregoing are desired.

### SUMMARY

In one exemplary embodiment, a protective case for an electronic device having a touch screen and an audio port is provided. The protective case includes a front portion, a back portion removably attached to the front portion, and a vent mesh. The front portion includes a rigid frame extending around a perimeter of the front portion, and a screen aperture configured to provide access to the touch screen of the electronic device when the electronic device is installed in the protective case. The back portion includes a sealing member configured to directly contact a portion of the electronic device proximate the audio port of the electronic device when the electronic device is installed in the protective case. The sealing member has an aperture defining a circumference configured to encircle the audio port of the installed electronic device and form a water-proof seal between the installed electronic device and the sealing member of the protective case. The vent mesh covers the aperture of the sealing member and is configured to allow air to pass through the vent mesh and to resist the flow of water through the vent mesh.

In one exemplary embodiment, a protective case for an electronic device having a touch screen, a microphone audio port, and a speaker audio port is provided. The protective case includes a front portion, a back portion removably attached to the front portion, and a vent mesh. The front portion includes a rigid frame extending around a perimeter of the front portion, and a screen aperture configured to provide access to the touch screen of the electronic device when the electronic device is installed in the protective case. The back portion includes a back surface and a plurality of back sidewalls extending from the back surface and a sealing member configured to directly contact a portion of the electronic device when the electronic device is installed in the protective case. The sealing member has a first aperture defining a circumference configured to encircle the speaker audio port of the installed electronic device and form a water-proof seal between the installed electronic device and the sealing member of the protective case and a second aperture defining a second circumference configured to encircle the microphone audio port of the installed electronic device and form a water-proof seal between the installed electronic device and the sealing member of the protective case. The vent mesh covers the first aperture and the second aperture of the sealing member and is configured to allow air to pass through the vent mesh and to resist the flow of water through the vent mesh.

In one exemplary embodiment, a protective encasement for an electronic device having an audio device is provided. The protective encasement includes an audio port configured to be proximate the audio device of the electronic device when the electronic device is installed in the protective encasement, the audio port covered by a vent mesh configured to allow the passage of audio pressure through the vent mesh. The protective encasement also includes a sealing member surrounding the audio device of the installed electronic device and configured to provide an air-tight seal between the protective encasement and the installed electronic device. The protective encasement also includes a chamber bounded by the vent, the sealing member, the encasement, and the installed electronic device and defining a volume of air, the volume of air resisting the flow of water through the sealing member.

### BRIEF DESCRIPTION OF THE DRAWINGS

FIG. 1 illustrates an elevated perspective view of an electronic device positioned in a protective case;

FIG. 2 illustrates an elevated perspective view of the protective case of FIG. 1;

FIG. 3 illustrates a bottom view of the protective case of FIG. 2;

FIG. 4 illustrates an exploded view of the protective case of FIG. 2;

FIG. 5 illustrates a side sectional view of the electronic device and the protective case of FIG. 1;

FIG. 6 illustrates a top sectional view of the protective case of FIG. 2;

FIG. 7 illustrates a sectional view of the electronic device and a back portion of the protective case of FIG. 1; and

FIG. 8 illustrates a perspective view of a lower portion of the back portion of the protective case of FIG. 2.

### DETAILED DESCRIPTION

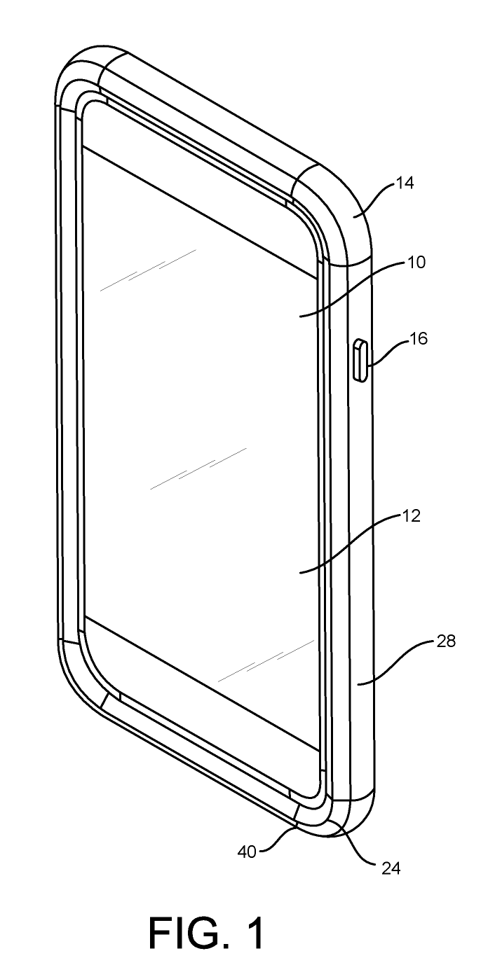

An exemplary electronic device 10 is illustrated in FIG. 1. Although a smartphone is illustrated, in other embodiments, electronic device 10 may be a tablet computer, a gaming device, an audio player, a video player, a fitness devise, a medical device, a camera, a portable computer, a two-way radio, a GPS receiver, and/or other portable devices. Electronic device 10 illustratively includes a touch screen 12, such as a capacitive touch screen, through which a user can interactive with electronic device 10.

Electronic device 10 is illustratively positioned in a protective case 14. In some embodiments, protective case 14 at least partially encloses a portion of electronic device 10 to provide protection from one or more forms of damage, such as damage from dust, water, snow, dirt, and drops or impacts.

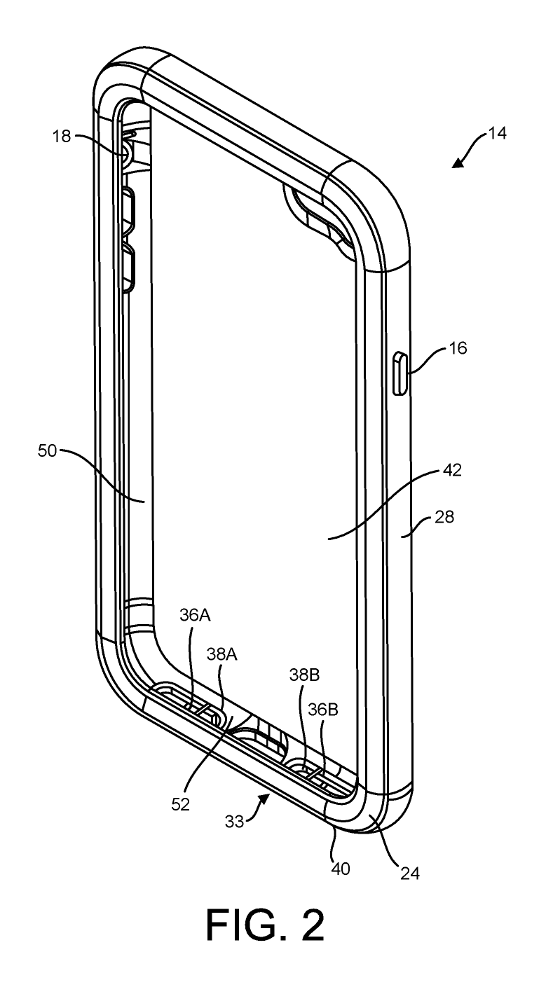

As shown in FIGS. 2-4, protective case 14 is illustratively includes a front portion 20 and a back portion 30. Front portion 20 and back portion 30 may include one or more button mechanisms 16 and/or rocker switches 18 positioned to allow a user to depress or rotate a button or switch (not shown) of electronic device 10 when the electronic device is installed in the protective case 14.

In some embodiments, front portion 20 is removably attached to back portion 30 through one or more clasping or coupling mechanisms 32. Exemplary clasping and coupling mechanisms are disclosed in U.S. Pat. Nos. 8,342,325 and 9,300,344, the disclosures of which are hereby incorporated by reference in their entirety.

Front portion 20 illustratively includes a screen aperture 22 allowing access to touch screen 12 of electronic device 10. In the embodiment illustrated in FIGS. 1-5, front portion 20 does not include a membrane covering screen aperture 22, allowing direct access by a user to the touch screen 12 of enclosed electronic device 10. In other embodiments, screen aperture 22 is spanned by a membrane (not shown) covering and protecting at least a portion of the touch screen 12 of enclosed electronic device 10.

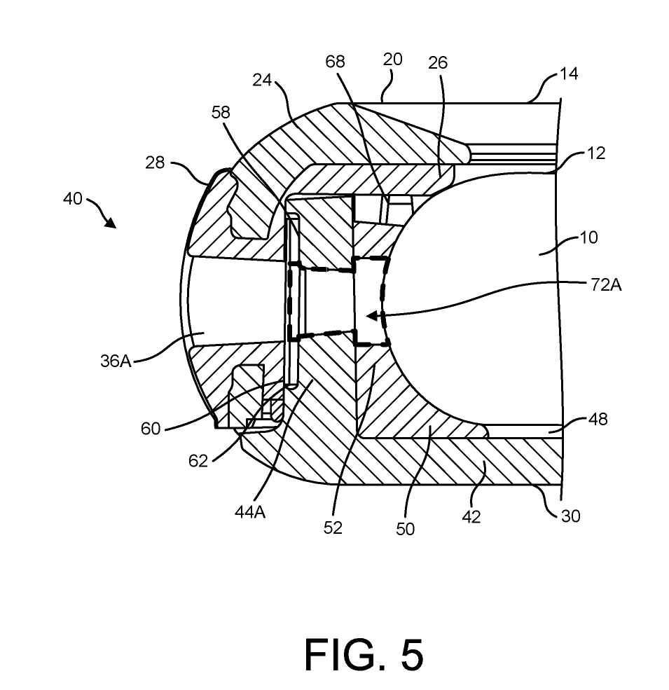

Front portion 20 illustratively includes a rigid frame 24 extending around a perimeter of front portion 20. In the exemplary embodiment illustrated in FIG. 5, rigid frame 24 extends above a portion of a front surface of electronic device 10 to provide protection to touch screen 12 of installed electronic device 10. Rigid from 24 further extends around a portion of one or more side surfaces of installed electronic device 10 to provide protection to the sides of installed electronic device 10.

In the exemplary embodiment illustrated in FIG. 5, front portion 20 also includes an upper seal 26 extending around screen aperture 22 in front portion 20 and configured to contact the front surface of installed electronic device 10. The contact between upper seal 26 and installed electronic device 10 is configured to resist the entry of a fluid such as water and/or dust or other debris from the environment from entering the interior of protective case 14. In other embodiments, front portion 20 does not include an upper seal 26 extending around screen aperture 22.

Referring to FIGS. 1-4, in some embodiments front portion 20 further includes a cushioning perimeter member 28 extending around the sides of rigid frame 24. Cushioning perimeter member 28 is illustratively formed from a softer, more impact-absorbing material than rigid frame 24. Cushioning perimeter member 28 provides a suitable grip surface for a user holding protective case 14, and provides additional impact protection should protective case 14 be dropped while enclosing electronic device 10. In the embodiment illustrated in FIG. 5, the upper seal 26 is formed from the cushioning perimeter member 28. In other embodiments, the upper seal 26 is distinct from and spaced apart from the cushioning perimeter member 28.

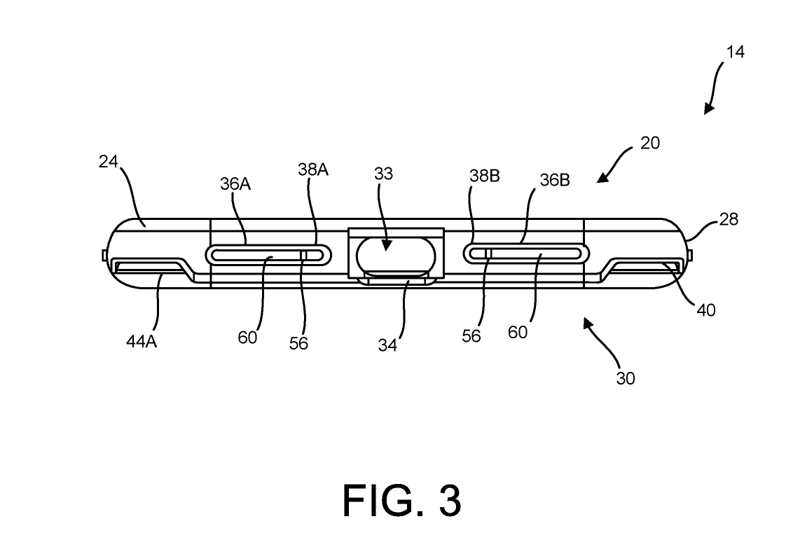

Referring next to FIG. 3, protective case 14 includes one or more charge ports 33 providing access to a charging port or data access port (not shown) of installed electronic device 10. A charge port cover 34 attached to one of front portion 20 and back portion 30 may be provided to seal charge port 33 from water and/or dust from an exterior environment.

Protective case 14 further includes one or more audio ports, such as speaker ports 36A, 36B positioned proximate one or more speakers of installed electronic device 10 and microphone ports 38A, 38B positioned proximate one or more microphones of installed electronic device 10. As illustrated in FIG. 3, speaker ports 36A, 36B and microphone ports 38A, 38B may be positioned on a bottom surface 40 of protective case 14. Sound waves produced by one or more speakers of installed electronic device 10 are transmitted to the user through one or more speaker ports 36, such as speaker ports 36A and 36B. Sound waves from the user or environment are transmitted through one or more microphone ports 38, such as microphone ports 38A and 38B also positioned on bottom surface 40 of protective case 14 adjacent corresponding speaker ports 36A and 36B, respectively, where they are received by a microphone of installed electronic device 10.

Referring next to FIGS. 2-5, back portion 30 of protective case 14 includes a back surface 42 and a plurality of back sidewalls 44 extending from the back surface 42. The plurality of back sidewalls 44 includes bottom sidewall 44A. In one exemplary embodiment, back surface 42 and back sidewalls 44 are formed from a substantially rigid material. Back surface 42 illustratively includes a back aperture 46 configured to align with a camera of installed electronic device 10. Back sidewalls 44 may include one or more clasping or coupling mechanisms 32 configured to releasably couple to corresponding coupling mechanisms 32 on the rigid frame 24 of the front portion 20.

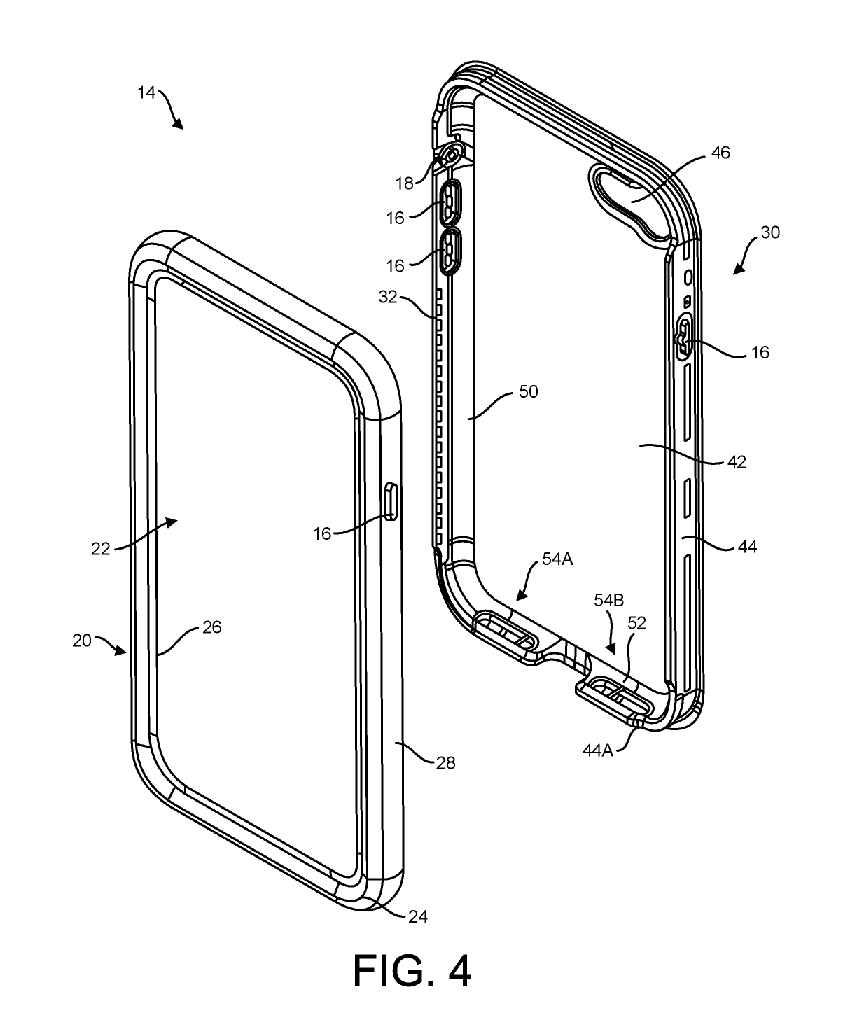

As illustrated in FIGS. 4, 5, 7, and 8, back portion 30 of protective case 14 further includes interior cushioning member 50. Interior cushioning member 50 is illustratively made of a softer, more impact absorbing materials than back surface 42 and back sidewalls 44. In some exemplary embodiments, cushioning member 50 is coupled to back surface 42 and the plurality of back sidewalls 44 through an overmolding process. In some exemplary embodiments, cushioning member 50 is coupled to back surface 42 and the plurality of back sidewalls 44 with a suitable permanent adhesive.

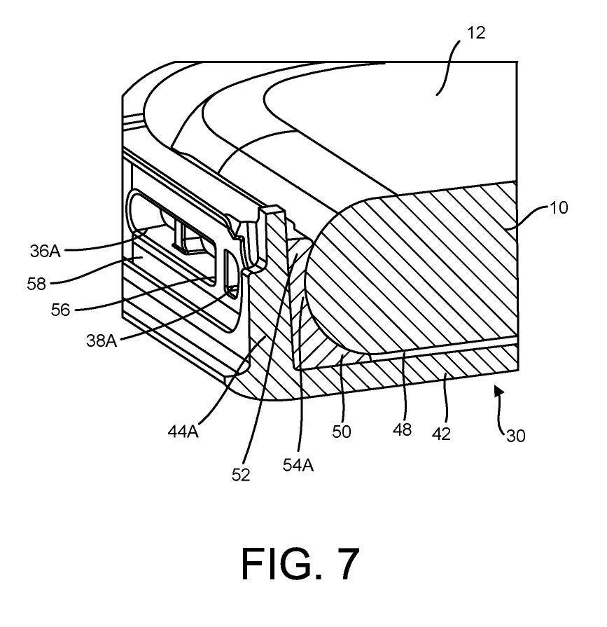

As shown in FIG. 4, interior cushioning member 50 extends around at least a portion of an interior perimeter of back portion 30. In some exemplary embodiments, interior cushioning member 50 extends around the entire interior perimeter of back portion 30. In some exemplary embodiments, interior cushioning member 50 is positioned to cover a corner formed between back surface 42 and the plurality of back sidewalls 44. In the exemplary embodiments illustrated in FIGS. 5 and 7, the interior cushioning member 50 is configured to cushion the enclosed electronic device 10 above and not touching the back surface 42 of back portion 30, forming a gap or cavity 48 defined between the back surface 42 of back portion 30 and a back surface of the enclosed electronic device 10.

Referring next to FIGS. 2 and 4-8, a sealing member 52 is illustrated. In the exemplary embodiments illustrated in FIGS. 2 and 4-8, the sealing member 52 is formed as part of the interior cushioning member 50. In other exemplary embodiments, the sealing member 52 is a separate piece independently coupled to back portion 30 of protective case 14, directly attached to front portion 20 or protective case 14, not directly attached to either front portion 20 or back portion 30 of protective case 14, or formed from a first segment attached directly to front portion 20 and configured to abut a second segment attached directly to back portion 30.

Sealing member 52 is illustratively positioned to contact electronic device 10 when electronic device 10 is received within protective case 14. Sealing member 52 contacts electronic device 10 proximate a speaker and/or microphone (not shown) of the electronic device 10, and defines a circumference that encircles one or more audio paths for a speaker and/or microphone of the device 10.

Sealing member 52 is illustratively formed from a flexible or elastomeric material. When the protective case 14 is assembled with the electronic device 10 installed inside, sealing member 52 is configured to create an air-tight and/or water-proof seal between the received electronic device 10 and the protective case 14. Sealing member 52 may be illustratively formed from an overmold or a compression molded part to follow a contour of the contacted portion of device 10.

In some exemplary embodiments, sealing member 52 has a contour similar to that of the adjacent portion of installed electronic device 10 and at least partially compresses against the adjacent portion of installed electronic device 10 to form the air-proof seal around the microphone and/or speaker of the electronic device 10 (See FIG. 5).

As illustrated in FIG. 5, an interior chamber 68 is formed between upper seal 26 and sealing member 52. Interior chamber 68 is illustratively at least partially bounded by upper seal 26, sealing member 52, installed electronic device 10, and bottom sidewall 44A. Interior chamber 68 may be waterproof at least due in part to the presence of a waterproof seal between upper seal 26 and installed electronic device 10.

As illustrated in FIGS. 3-6, speaker ports 36A, 36B and microphone ports 38A, 38B are each partially defined by cutouts and/or apertures in cushioning perimeter member 28 of front portion 20 and bottom sidewall 44A and sealing member 52 of bottom portion 30. In other exemplary embodiments, the audio ports 36, 38 are defined but cutouts and/or apertures in sealing member 52 or in bottom sidewall 44A and sealing member 52.

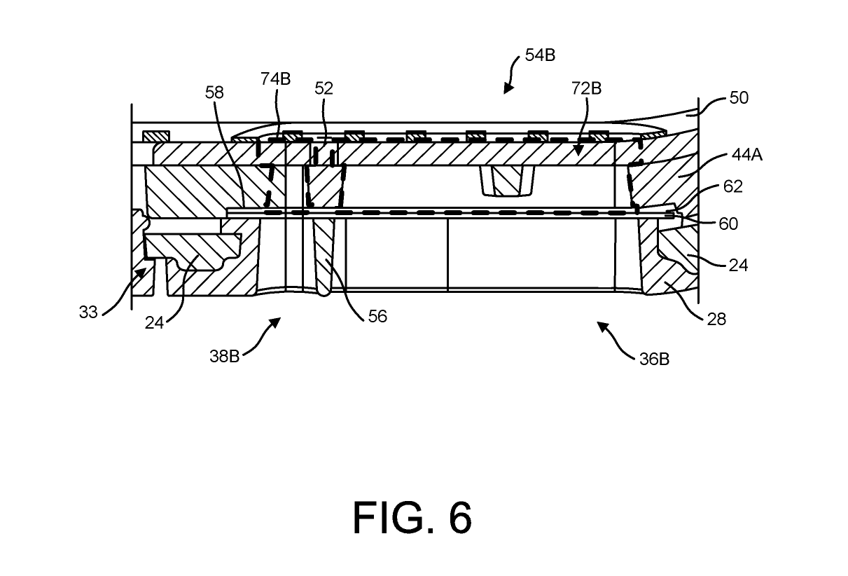

Referring to FIG. 6-8, sealing member 52 includes a first portion 54A surrounding speaker port 36A and microphone port 38A and a second portion 54B connected to the first portion, the second portion surrounding speaker port 36B and microphone port 38B. In other embodiments, sealing member 52 may only surround speaker port 36A and microphone port 38A, or may be composed of multiple distinct and spaced apart segments 54, each segment 54 encircling one or more speaker ports 36 and/or one or more microphone ports 38.

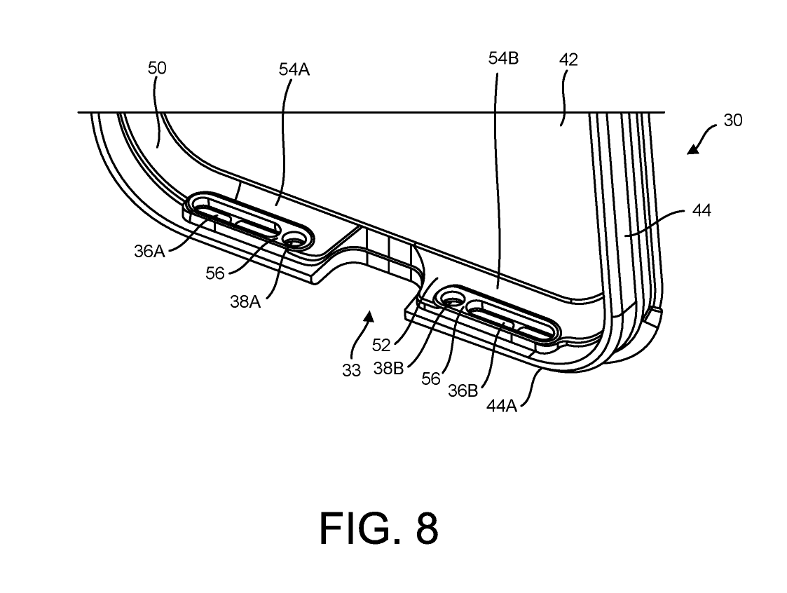

Referring to FIGS. 6 and 8, each speaker port 36A, 36B is acoustically separated from the corresponding neighboring microphone port 38A, 38B with an acoustic divider 56. Acoustic divider 56 acoustically isolates each speaker port 36 from the corresponding proximate neighboring microphone port 38. Acoustic divider 56 is illustratively formed from a portion of cushioning perimeter member 28, vent mesh 60, adhesive layer 62, bottom sidewall 44A, and sealing member 52.

Vent mesh 60 is illustratively positioned in the audio port 36, 38 between front portion 20 and back portion 30 of the protective case 14. Vent mesh 60 is illustratively formed from a woven mesh, such as the Acoustex® precision woven mesh available from SAATI S.P.A. Vent mesh 60 is configured to allow air, such as sound waves, to pass through vent mesh 60 in a speaker port 36 and/or microphone port 38. In some exemplary embodiments, the vent mesh 60 is substantially transparent to an audio signal passing through vent mesh 60, but resists the flow of water through the woven mesh.

In some exemplary embodiments, vent mesh 60 has a pore size as large as 100 micron or less, 75 micron or less, 50 micron or less, 40 micron or less, 30 micron or less, 25 micron or less, 20 micron or less, 15 micron or less, or within a range defined between any two of the foregoing values, such as 15 micron to 100 micron, 15 micron to 40 micron, 20 micron to 40 micron, 25 micron to 40 micron, or 25 micron to 30 micron.

Vent mesh 60 is illustratively connected to back portion 30 with adhesive layer 62. Adhesive layer 62 is illustratively shaped to fit in a recess 58 formed in back portion 30. Exemplary adhesives include double-sided pressure-sensitive closed-cell acrylic foam adhesives. Adhesive layer 62 illustratively includes one or more cutouts or apertures corresponding with ports 36 and/or speaker ports 38.

Referring next to FIGS. 5 and 6, each audio port 36, 38 includes an audio port chamber 72, 74 defined therein. Each speaker port 36A, 36B includes a corresponding speaker port chamber 72A, 72B. Each microphone port 38A, 38B includes a corresponding microphone port chamber 74A, 74B. Exemplary audio port chambers 72A, 72B, 74B are illustrated by dotted lines in FIGS. 5 and 6. Each audio port chamber 72, 74 is illustratively bounded by vent mesh 60, adhesive layer 62, bottom sidewall 44A of back portion 30 (including a portion of acoustic divider 56), sealing member 52, and the installed electronic device 10.

In the exemplary embodiment illustrated in FIG. 6, the neighboring speaker port chamber 72B and microphone port chamber 74B are not acoustically connected and are spaced apart and separated by acoustic divider 56. In other exemplary embodiments, a speaker port chamber 72 is not separated from a neighboring microphone port chamber 74 by an acoustic divider 56 and share a common audio port chamber 72, 74.

Although vent mesh 60 is configured to allow sound waves to pass through vent mesh 60, each audio port chamber 72, 74 forms a defined volume of air when electronic device 10 is installed in protective case 14. It has been found that this defined volume of air within each audio port chamber 72, 74 resists the intrusion of fluid such as water through vent mesh 60 provided that an air-proof seal is maintained between sealing member 52 and installed electronic device 10. For example, referring to FIG. 5, upon exposure of the outside of speaker port 36A to water, the water will partially intrude into microphone port 36A until encountering vent mesh 60. The air in speaker port chamber 72A is sealed in the volume of speaker port chamber 72A between vent mesh 60 and the air-proof seal formed between sealing member 52 and installed electronic device 10. The sealed speaker port chamber 72A resists the entry of water through vent mesh 60 and into sealed speaker port chamber 72A.

In some embodiments, the ability of vent mesh 60 and audio port chamber 72, 74 allow for a degree of water resistance for protective case 14, which protects the microphone and/or speakers of electronic device 10 from being contacted with water and potentially damaging electronic device 10. Moreover, the substantial transparency of vent mesh 60 to acoustic waves provides superior audio transmission through vent mesh 60 compared to typical semi-permeable hydrophobic membranes.

Without wishing to be held to any particular theory, it is believed that each audio port chamber 72, 74 provides a sealed volume of air within the audio port chamber 72, 74 that must be displaced from the audio port chamber 72, 74 before water can pass through vent mesh 60. In some exemplary embodiments, the combination of vent mesh 60 and audio port chamber 72, 74 resist the entry of water for at least 30 minutes up to a pressure up to a depth as great as 0.5 m (0.7 psi), 1.0 m (1.4 psi), 1.4 m (2.0 psi), 1.5 m (2.1 psi), 2.0 m (2.8 psi), or greater, or within a range defined between any two of the foregoing values, such as 0.5 m to 2.0 m, 0.5 m to 1.5 m, or 1.0 m to 1.5 m. In some exemplary embodiments, the combination of vent mesh 60 and audio port chamber 72, 74 resist the entry of water for at least to 60 minutes up to a pressure up to a depth as great as 0.5 m (0.7 psi), 1.0 m (1.4 psi), 1.4 m (2.0 psi), 1.5 m (2.1 psi), 2.0 m (2.8 psi), or greater, or within a range defined between any two of the foregoing values, such as 0.5 m to 2.0 m, 0.5 m to 1.5 m, or 1.0 m to 1.5 m.

The elements, components, and steps described herein are meant to exemplify some types of possibilities. In no way should the aforementioned examples limit the scope of the invention, as they are only exemplary embodiments.

The phrases “in some embodiments,” “according to some embodiments,” “in the embodiments shown,” “in other embodiments,” “in some examples,” “in other examples,” “in some cases,” “in some situations,” “in one configuration,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

The foregoing disclosure has been presented for purposes of illustration and description. Other modifications and variations of the disclosed techniques may be possible in view of the above teachings. The embodiments described in the foregoing disclosure were chosen to explain the principles of the concept and its practical application to enable others skilled in the art to best utilize the invention. It is intended that the claims be construed to include other alternative embodiments of the invention, except as limited by the prior art.

What is claimed is:

1. A protective case for an electronic device having a touch screen and an audio port, the protective case comprising:
a front portion including a rigid frame extending around a perimeter of the front portion, and a screen aperture configured to provide access to the touch screen of the electronic device when the electronic device is installed in the protective case;
a back portion configured to be removably attachable to the front portion and including a sealing member configured to directly contact a portion of the electronic device proximate the audio port of the electronic device when the electronic device is installed in the protective case, the sealing member having an aperture defining a circumference configured to encircle the audio port of the installed electronic device and form a water-proof seal between the installed electronic device and the sealing member of the protective case, and;
a vent mesh covering the aperture of the sealing member, the vent mesh being configured to allow air to pass through the vent mesh and to resist the flow of water through the vent mesh.

2. The protective case of claim 1, wherein the front portion further comprises an upper seal extending around the screen aperture and configured to contact a front surface of the electronic device when the electronic device is installed in the protective case.

3. The protective case of claim 2, wherein the back portion further includes a back surface and a bottom back sidewall extending from the back surface, and wherein the upper seal is adapted to form a waterproof interior chamber at least partially bounded by the upper seal, the sealing member, the bottom back sidewall, and a portion of the electronic device when the electronic device is installed in the protective case.

4. The protective case of claim 1, wherein the back portion further includes a back surface, a plurality of back sidewalls extending from the back surface, and an interior cushioning member extending around at least a portion of an interior perimeter of the back portion.

5. The protective case of claim 4, wherein the sealing member comprises a portion of the interior cushioning member.

6. The protective case of claim 4, wherein the sealing member is configured to form a cavity defined between the back surface of the back portion of the protective case and the electronic device when the electronic device is installed in the protective case.

7. The protective case of claim 1, further comprising an audio port chamber adapted to enclose a volume of air defined between the vent mesh, sealing member, and electrical device, the audio port chamber being configured to resist a flow of water through the vent mesh when the electronic device is installed in the protective case.

8. The protective case of claim 1, wherein the sealing member includes a second aperture defining a second circumference configured to encircle a second audio port of the installed electronic device and form a second water-proof seal between the installed electronic device and the sealing member of the protective case and the vent mesh further covers the second aperture of the sealing member.

9. The protective case of claim 8, wherein the aperture and the second aperture of the sealing member are acoustically separated by an acoustic divider.

10. The protective case of claim 1, further comprising an audio port channel configured to align with the audio port of the electronic device when the electronic device is installed in the protective case, the audio port channel passing through the vent mesh and at least partially defined by the rigid frame of the front member and a sidewall of the back portion.

11. A protective case for an electronic device having a touch screen, a microphone audio port, and a speaker audio port, the protective case comprising:
a first portion including a rigid frame extending around a perimeter of the front portion, and a screen aperture configured to provide access to the touch screen of the electronic device when the electronic device is installed in the protective case;
a second portion removably attachable to the front portion, the second portion including a surface and a plurality of sidewalls extending from the surface, the second portion further comprising a sealing member configured to directly contact a portion of the electronic device when the electronic device is installed in the protective case, the sealing member having a first aperture defining a circumference configured to encircle the speaker audio port of the installed electronic device and form a water-proof seal between the installed electronic device and the sealing member of the protective case and a second aperture defining a second circumference configured to encircle the microphone audio port of the installed electronic device and form a water-proof seal between the installed electronic device and the sealing member of the protective case, and;
a vent mesh covering the first aperture and the second aperture of the sealing member, the vent mesh being configured to allow air to pass through the vent mesh and to resist the flow of water through the vent mesh.

12. The protective case of claim 11, further comprising an audio port channel configured to align with the audio port of the electronic device when the electronic device is installed in the protective case and allow sound waves to pass between the audio port of the electronic device and an external environment, the audio port channel passing through the vent mesh and at least partially defined by the rigid frame of the first member and a sidewall of the plurality of sidewalls of the second portion.

13. The protective case of claim 12, wherein the audio port channel includes an audio port chamber adapted to enclose a volume of air defined between the vent mesh, sealing member, and electrical device when the electronic device is installed in the protective case is configured to resist a flow of water through the vent mesh, the audio port chamber configured to resist a flow of water through the vent mesh when the electronic device is installed in the protective case.

14. The protective case of claim 13, wherein the second portion further includes an interior cushioning member extending around at least a portion of an interior perimeter of the second portion, the sealing member comprising a portion of the interior cushioning member.

15. The protective case of claim 13, wherein the first aperture and the second aperture of the sealing member are acoustically separated by an acoustic divider.

16. The protective case of claim 15, wherein the plurality of sidewalls includes a bottom sidewall, and wherein the acoustic divider is formed from a portion of the bottom sidewall, a portion of the vent mesh, and a portion of the sealing member.

17. A protective encasement for an electronic device having an audio device, the protective encasement including:
an audio port configured to be proximate the audio device of the electronic device when the electronic device is installed in the protective encasement, the audio port covered by a vent mesh configured to allow the passage of audio pressure through the vent mesh;
a sealing member configured to surrounding the audio device of the installed electronic device and to provide an air-tight seal between the protective encasement and the installed electronic device; and
a chamber bounded by the vent mesh, the sealing member, the encasement, and the installed electronic device and defining a volume of air, the volume of air resisting the flow of water through the sealing member.

18. The protective encasement of claim 17, further including a front portion configured to cover a first portion of the installed electronic device and a back portion releasably coupled to the front portion, the back portion configured to cover a second portion of the installed electronic device.

19. The protective encasement of claim 18, wherein the back portion includes a cushioning member forming an interior perimeter of the back portion, the sealing member forming a portion of the cushioning member.

20. The protective encasement of claim 16, further comprising an acoustic divider acoustically isolating the audio port of the protective encasement into a first port and a second port, the first port configured to be proximate the audio device of the installed electronic device and the second port configured to be proximate a second audio device of the installed electronic device.
